(19) United States
(12) Patent Application Publication
(10) Pub. No.: US 2011/0202428 A1
(43) Pub. Date: Aug. 18, 2011

(54) BUSINESS METHOD OF REAL TIME GROUP BUYING

(76) Inventor: Gun Chul Jung, Incheon (KR)

(21) Appl. No.: 13/124,561

(22) PCT Filed: Oct. 23, 2008
(86) PCT No.: PCT/KR08/06271

§ 371 Date: Apr. 15, 2011

(30) Foreign Application Priority Data
Oct. 15, 2008 (KR) 10-2008-0100921

(51) Int. Cl. G06Q 30/00

(52) U.S. Cl. 705/26.41

(57) ABSTRACT

This invention is a kind of business method in electronic commerce for real-time group-buying, wherein buyers can buy commodities for the cheapest price through buyers organize automatically a buying grouping that buys the same goods during some time wherever they select commodities. This invention as a business method is the method comprising: 1) prepare the group-buying including registering buyers and sellers, 2) select commodities, 3) register buying-intention, 4) extract sellers, 5) transfer selling information, 6) select buying method, 7) register a buying contract, 8) transact the buying contract. This invention for a real-time group-buying enables buyers to prevent their buying from mutual consent between sellers, profiteering due to mutual consent and dishonesty by the operator of this invention of group-buying, because buying amount gathered through ‘Group-buying Server’ makes the buyers' group dominant and because buyers in group-buying can search all sellers and their ‘the terms of selling including prices’. Also, this invention enables buyers to overcome sellers' influence and to buy in real-time through group-buying, because buyers share their buying information by P2P method.

### TECHNICAL FIELD

This invention is a kind of business method in electronic commerce for real-time group-buying, wherein buyers can buy commodities for the cheapest price through buyers organize automatically a buying group that buys the same goods during some time wherever they select commodities.

### BACKGROUND ART

Conventional group-buying methods are comprised of two types. One is a method by such offline grouping as companies, cooperatives, unions. And another is a method by Internet Group-buying.

In said method by such offline grouping as companies, cooperatives, unions; some big buyers who can buy much more than almost buyers through one channel by grouping can buy cheaper commodities (hereinafter “commodities” means “commodities and services”) because they influence sellers to compete each other. Companies, cooperatives, or unions have many affiliates or many members.

Recently, another group-buying method using the Internet appears. Said method by Internet Group-buying, comprising:

1) an intermediary of group-buying (usually an intermediary of group-buying operator is the same as a group-buying server operator) makes buyers gather by the time that buying amount is more than criterion,

2) the intermediary extract a seller who quote cheaper,

3) buyers buy through the seller.

Said conventional group-buying methods have following problems:

1) buyers cannot know the lowest price because sellers especially B2B sellers are reluctant to disclose their ‘the terms of selling including prices’ including prices discounted for group-buying, and buyers cannot avoid collusion between sellers;

2) offline intermediaries of group-buying cannot extract the best sellers among too many sellers because they are a minority and sellers who participate in are limited, and also buyers cannot avoid collusion between sellers and the group-buying operator;

3) if buyers buy by group-buying through the Internet, buyers who want to buy by group-buying cannot buy in real-time because they have to wait for some period in order to make buying amount, and cannot keep an eye on an intermediary of group-buying in order to prevent group-buying from cheating;

4) it is required to search all prices by each commodity, but a minority of intermediaries of group-buying cannot search the best seller in the world because kinds of commodities are too many.

### DISCLOSURE OF INVENTION

### Technical Problem

As conventional group-buying methods have problems as above, new invention of group-buying must have following merits:

1) can overcome such sellers' resistance as hiding prices, collusion;

2) can keep an eye on an intermediary of group-buying; and further, can buy by group-buying without group-buying operator;

3) buyers for group-buying can buy in real-time; and further, buyers cannot distinguish between group-buying and individual buying;

4) buyers can buy every commodity which they want without limitation in kinds of commodities.

### Technical Solution

In order to solve the above technical problems, this invention needs following preparations;
buyers install a client module which is a kind of a computer program in their PC;
the intermediary who operates this invention of group-buying prepares a group-buying server;
sellers register their information, commodities and ‘the terms of selling including prices’ in ‘Group-buying Server’.

Each preparation functions as followings:
a client module at a buyer's PC communicates data with ‘Group-buying Server’, and makes said data shown on PCs of buyers or sellers; in which said data means directions, information, and results of processes necessary for electronic commerce by this invention;
the group-buying server (hereinafter ‘Group-buying Server’), collects inputs from PCs of buyers and sellers, produces statistical results through analysis, transfers information or directions for each step of electronic commerce to PCs of buyers and sellers, and does others for electronic commerce by this invention.

This invention comprises:

1. If a buying intent on a certain buyer reveals through the buyer selects some commodities at a certain shopping mall, and if he has already connected to ‘Group-buying Server’ which is operated by the intermediary, the buying intent is transferred to ‘Group-buying Server’;
in which a certain shopping mall includes group-buying mall run by the intermediary of the group-buying, shopping malls by the sellers registered in ‘Group-buying Server’ (hereinafter ‘Sellers Registered’), and shopping malls by the sellers unregistered in ‘Group-buying Server’;

2. If a certain buyer selects commodities at a certain shopping mall by the sellers unregistered in ‘Group-buying Server’ (hereinafter ‘Sellers Unregistered’), selling information including the prices of the selected commodities. And unregistered prices of ‘Sellers Registered’ is transferred to ‘Group-buying Server’;

3. ‘Group-buying Server’ extracts a list of sellers who sell the selected commodities in order of advantage to buyers in ‘the terms of selling including prices’ such as the lowest price, and transfers it to the registered buyers' xxPC, and then ‘Group-buying Server’ transfers information of buying including buying intent and records of buying during some period to the registered sellers' PC;

4. the buyer who becomes known a situation of market selects the best seller including group-buying from ‘Sellers Registered’ or buying from unregistered sellers;

5. If the buyer selects group-buying, the buyer's PC registers the selection, and ‘Group-buying Server’ transacts the contract, which includes ‘Group-buying Server’ informs to the buyer's PC and the seller's PC, of the contract and of such ‘data for transaction of the contract’ as payment method, delivery destination, bank account number, etc.

6. ‘Group-buying Server’ settles the accounts of the buyer and the seller including calculation of the commission and the mileage.

### ADVANTAGEOUS EFFECTS

This invention of real-time group-buying business method makes big buying power through gathering scattered buyers, so the big buying power seduce sellers and presses the sellers to quote a lower price.

As this invention of ‘business method of real-time group-buying wherever buyers buy’ makes buyers search ‘the terms of selling including prices’ of various sellers for the commodity which the buyer wants, and transfer ‘the terms of selling including prices’ to ‘Group-buying Server’; this invention enables buyers to see various sellers and ‘the terms of selling including prices’, and to prevent fundamentally mutual consent between sellers, profiteering and dishonesty by the operator of group-buying server.

As this invention of real-time group-buying business method enables all buyers to share ‘the terms of selling including prices’ of various sellers by P2P method, which each buyer collects; this invention enables buyers to buy for the lowest price in the worldwide market, and to overcome sellers' influence including mutual consent between sellers.

This invention of real-time group-buying business method enables buyers to know ‘the terms of selling including prices’ of group-buying while buyers register their buying intent at any shopping mall wherever they register, and enables to buy in real-time by group-buying when buyers select commodities at any shopping mall wherever buyers select.

This invention of real-time group-buying business method enables buyers to buy all commodities in the world without limit or exception because information of every commodity is collected by buyers by P2P whenever buyers select commodities at any shopping mall wherever buyers select.

### BRIEF DESCRIPTION OF DRAWINGS

FIG. 1 is a flow chart illustrating a business method of this invention.

### MODE FOR THE INVENTION

Term ‘Group-buying’ in this invention means that buyers buy commodities from sellers registered on ‘Group-buying Server’.

‘Participants’ in this invention are comprised of buyers, intermediary, and sellers.

‘Intermediary’ is an operator of ‘Group-buying Server’ in order to realize this invention. ‘Buyers’ are bodies who buy commodities using their PCs (personal computers) including ‘Client Module’ which communicates with ‘Group-buying Server’ automatically. ‘Sellers’ are bodies who sell commodities. ‘Group-buying mall’ is an Internet Shopping mall in ‘Group-buying Server’ in which ‘Sellers registered on ‘Group-buying Server” sells their commodities.

If a certain buyer who is communicating automatically with ‘Group-buying Server’ by ‘Client Module’ selects a commodity or commodities which he wants at a certain shopping mall, or said buyer reveal his buying intent clearly; the buying intent gets transferred to ‘Group-buying Server’. Said ‘a certain shopping mall’ includes the group-buying mall operated by the operator of this group-buying server, shopping malls operated by sellers (hereinafter ‘Sellers Registered’) who have registered themselves on ‘Group-buying Server’, and shopping malls operated by sellers who have not registered yet themselves on ‘Group-buying Server’.

If buyers select some commodities at a certain shopping malls except ‘Group-buying Server’, selling information including prices of said commodities gets transferred to ‘Group-buying Server’, whether said prices are registered on ‘Group-buying Server’ or not.

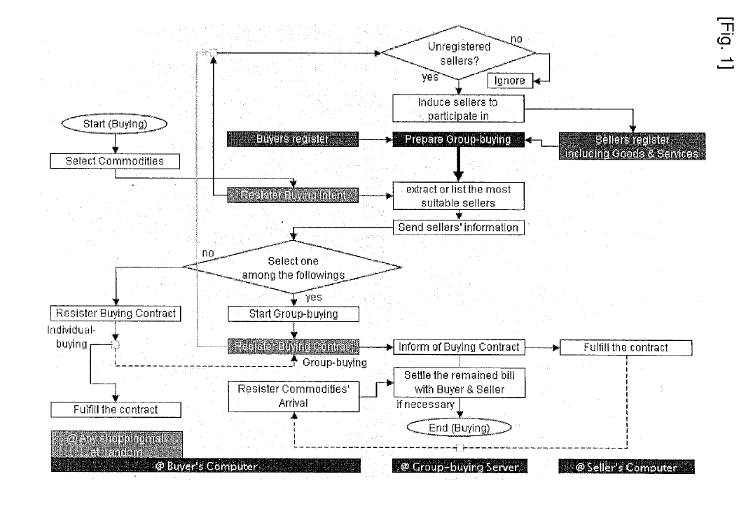

Steps for group-buying by ‘Participants in this invention’ are shown in FIG. 1.

A step for group-buying preparation comprises:
buyers and sellers register themselves as members of said group-buying of this invention;
buyers download ‘Client Module’ for participation in said group-buying;
sellers register their commodities and ‘the terms of selling including prices’.

Buyers and sellers make an organization for group-buying through said step.

Said sub-step for registration of buyers and sellers is similar to conventional/current method of Electric Commerce. Said sub-step comprises:
‘Intermediary’ receives ‘application for participation’ from buyers and sellers who hope to participate in;
‘Intermediary’ approves said ‘application for participation’ by qualification;
‘Intermediary’ contract with buyers and sellers approved for using ‘Group-buying Server’ according to an agreement.

Said agreement can include such terms and conditions for this invention as dividends, commissions, rights and duties of members, payment method, conditions that said members must observe, etc.

Buyers and sellers who agree to said agreement become members of said group-buying.

Sellers are divided into ‘Sellers Registered’ and sellers who have not registered yet.

Said sellers unregistered can register themselves as members of said group-buying by the method comprising:

1) Buyers pick commodities at a certain shopping mall;

2) buyers' PC send information of said commodities to ‘Group-buying Server’;

3) ‘Group-buying Server’ send an e-mail proposing participation in said group-buying automatically if said seller is not registered as a member of said group-buying;

4) the seller to receive said proposal becomes a seller registered if he agree to said proposal, or he remains a seller unregistered if he disagree to said proposal;

5) ‘Group-buying Server’ can give disadvantage to sellers to disagree, for example, sellers to disagree are not shown to buyers;

A sub-step for registration of commodities and services; wherein sellers log in ‘Group-buying Server’, and register or change their commodities and prices.

As sellers can know buying pattern and buying amount of buyers statistically through ‘Group-buying Server’, they can register or change their ‘the terms of selling including prices’ including prices in order to compete with others.

Said ‘the terms of selling including prices’ includes prices, due-date, mileage, whether to pay delivery fee or not, whether to get supplies or not, etc.

Sellers can register their ‘the terms of selling including prices’ according to buying amount of each buyer. For example, sellers register various prices by commodity, and enable any buyers who buy much more to pay a low price.

Also, sellers can register special prices for such special days as Christmas, holydays, a sale season. Sellers can register advantageous prices according to buying amount accumulated for some period of each buyer.

The group-buying server shows buyers ‘the terms of selling including prices’ which match to each buyer. As a result of that, each buyer sees prices different from other buyers according to buying amount or buying frequency.

The group-buying server makes an organization through buyers and sellers register themselves as members of said group-buying as above. Said organization of buyers and said organization of sellers are shown in the database of ‘Group-buying Server’. Said organization of buyers acts as influence to sellers, said organization of sellers acts as buying information.

In this invention; as ‘Group-buying Server’ catches information of sellers and their ‘the terms of selling including prices’ which is selected by buyers, and enables buyers to share; buyers can buy from the most advantageous sellers.

That is to say, ‘Intermediary’ needs not to make efforts to find the most optimum seller(s), and buyers can overcome sellers' influence including mutual consent between sellers or between ‘Intermediary’ and sellers.

‘Intermediary’ enables the buyers who are approved as members to install ‘Client Module’ for buyers through downloading from ‘Group-buying Server’.

Said ‘Client Module’ can resides at RAM through ‘Client Module’ gets executed during booting process, or through buyers executes ‘Client Module’ by such method as clicking an icon. If buyers execute ‘Client Modules’ through said method, buyers complete preparation for this invention of group-buying because buyers' PCs are connected to ‘Group-buying Server’ through the Internet

Sellers can use Client module' for their convenience like buyers as above, but sellers can sell by this invention of group-buying without ‘Client Module’ because registration of commodities and browsing statistical data are possible by logging in ‘Group-buying Server’ directly.

A step for registration of buying intent is a step wherein buyers put commodities which they want in the shopping cart or a step wherein buyers put commodities which they can buy in the future in the wish list.

The method to put commodities in the shopping cart or the wish list is comprising:

1) buyers search commodities which they want at a certain shopping mall, and buyers put the selected commodities in the shopping cart or the wish list of said shopping mall;

2) information of said commodities, the ‘the terms of selling including prices’ including price and information of said seller get sent to ‘Group-buying Server’

Another method of registration of buying intent is the method wherein ‘Client Module’ sends a purchase order filled by a buyer.

Said purchase order filled can be used for buying approval by the buyer, payment approval by the buyer, etc.

Another method of registration of buying intent is the method wherein buyers move to a certain shopping mall which is not registered on the ‘Group-buying Server’, and buyers put commodities in the shopping cart or the wish list of said shopping mall according to buying process of said shopping mall; besides buyers buy the commodities registered on ‘Group-buying Server’ by registered sellers

When buyers put commodities in the shopping cart or the wish list of said shopping mall during said step for registration of buying intent, information of said commodities, the ‘the terms of selling including prices’ including price and information of said seller get sent to ‘Group-buying Server’ automatically.

The method for registration includes followings:

1) automatically soon when buyers put commodities in the shopping mall or the wish list of a certain shopping mall

2) automatically soon when buyers select commodities

3) automatically soon when buyers input a command of registration.

Said ‘a certain shopping mall’ includes sellers registered on ‘Group-buying Server’ and sellers unregistered.

If the selected sellers are unregistered on ‘Group-buying Server’, ‘Group-buying Server’ sends mails proposing participations automatically.

So the database in ‘Group-buying Server’ can enlarge continuously information of sellers by said method registering ‘unregistered sellers’.

Said database is comprising:

1) it can identify each commodity whether each commodity which a buyer select are the same as one of standard commodities catalog;

2) it can be shown to buyers like usual shopping malls;

3) buyers can search commodities in it;

4) buyers can compare each selling condition including price.

5) As statistical result through integrating buying intent of all buyers participated is group-buying amount, it becomes influence to sellers.

A step for extraction of sellers, which is proceeded at ‘Group-buying Server’, is comprising:

1) ‘Group-buying Server’ identifies the commodities registered at the previous step because each commodity can be the same though the names of the commodity are different from each other;

2) ‘Group-buying Server’ makes a list of sellers in order of advantageousness to buyers in ‘the terms of selling including prices’, whether sellers are registered or not.

If there are no sellers registered on ‘Group-buying Server’ who have the commodities selected by a certain buyer, ‘Group-buying Server’ makes the buyer buy individually, not by this invention of group-buying. Said case can be explained as the buyer selects the best seller through comparing ‘the terms of selling including prices’ of each seller about identical commodity, whether it is this invention of group-buying or not. So this invention of group-buying acts like ‘price comparison’ in said case.

A step for extraction of sellers is the step; wherein ‘Group-buying Server’ extracts the sellers who sells the commodities registered at the step for registration of buying intent, and makes a list of sellers in order of advantageousness in ‘the terms of selling including prices’ (usually price) to buyers.

‘Group-buying Server’ may make said list of sellers including sellers registered only or including sellers unregistered only. Though a buyer selects commodities at a certain shopping mall of a seller unregistered, information of the seller is included in said list of sellers.

Sellers who last for shorter period than the criterion or/and sellers who are unregistered and caught by another buyer can be excluded in order to protect sellers registered.

As such ‘the terms of selling including prices’ except price as due-date, delivery fee, giving related supplies, mileage are usually similar, the list of sellers is usually made by price, or sometimes by price under the same ‘the terms of selling including prices’ except price.

A step for sending sellers' information is the step wherein ‘Group-buying Server’ sends said list of sellers and information of the selected commodities including names and designations of the commodities to the buyers' PC.

‘Group-buying Server’ need not send said information because it is not essential to this invention of group-buying to send said information.

Statistical information about this invention of group-buying includes:

the number of buyers registered,
the number of buyers for some period,
the average buying amount during some period,
price information including the lowest, the highest, the average, etc; and
selling information can includes said statistical information.

Information about commodities can include a list of seller by such selling condition as price, due-date, or region.

Said information for selling condition can be shown by pop-up windows on the PC of buyers' and sellers'.

A step for selecting one among buying methods is the step wherein the buyer selects the group-buying which means to select the optimum one among sellers registered, or selects the individual-buying if there are no sellers registered, or if it is impossible to buy from sellers registered, or if there are no benefit of this invention of group-buying, or if it is such special cases as quick delivery, or if they have long-lasting relationship.

Buyers can set up that their PCs always select the group-buying automatically for their convenience.

A step for registration of a buying contract is the step wherein the selected result at the previous step gets sent to ‘Group-buying Server’, so ‘Group-buying Server’ receives the buying contract.

In usual electric commerce, buyers and sellers conclude their contracts through two steps as follows:

1. Sellers quote through sellers register their ‘the terms of selling including prices’ for their commodities;

2. Buyers accept through buyers put some commodities in the shopping cart.

In this invention of group-buying; the buyer contracts with a seller unregistered if the buyer selects individual-buying, or the buyer contracts with a seller registered if the buyer selects group-buying.

All data had better be sent to ‘Group-buying Server’ in order to collect data as much as possible whether buyers select an individual buying or buyers select a group-buying,

otherwise only contracts of group-buying can be sent if contracts of individual-buying are not needed.

Accumulated data of each buying of each buyer are used for showing buying amount during some period to sellers.

Sellers can give such advantages as Mileage Points to buyers who buy frequently on the basis of said accumulated data.

A step for informing the buyer and/or the seller who contract each other in order to transact business is the step; wherein

‘Group-buying Server’ transfers data for the transaction of group-buying including buying intent, commission, price, buyer's address, to the buyer and/or the seller who contract each other if the contract become valid,

in order that the buyer and the seller can use the data at the following steps.

‘Settlement of an account’ includes followings:

1) the buyer pays for the commodities

2) ‘Group-buying Server’ makes a commission remain,

3) the others, including accumulating miles or points.

This invention of group-buying can include a function to settle an account, comprising:

1) if a result selected by the buyer is group-buying, the result selected is transferred to ‘Group-buying Server’, and also the buyer sends the payment for the commodities to ‘Intermediary’ who is operating ‘Group-buying Server’ during ‘the step for registration of a buying contract’;

2) ‘Group-buying Server’ settles the account with the seller considering a commission of the group-buying when the buyer informs ‘Group-buying Server’ that he receives the commodities during ‘the step for informing the buyer and/or the seller of the contract in order to transact business’;

It is possible that ‘Group-buying Server’ remits money automatically to the sellers when the buyer receives the commodities or when the contract become valid, after the buyer and the seller make their account.

‘Intermediary’ can be a seller, who registers as a seller on ‘Group-buying Server’, and open his shopping mall in the Internet in this invention.

Said selling is similar to Private Brand Selling which is shown in whole sale mart.

This invention can include ‘group-buying through sub-group’.

Examples of Intermediaries of sub-groups are usually Representative Conference of Residents including sellers' unions of conventional markets.

If a member of said sub-group buys some commodities, ‘Group-buying Server’ registers it as if the sub-group buys because the member registers himself as a member of the sub-group for identification.

An intermediary of a sub-group is responsible for a destination of delivery.

If this invention of group-buying through sub-group happens, sellers can reduce work to deliver due to delivery to one destination, and buyers can buy for cheaper price due to bigger buying amount.

### INDUSTRIAL APPLICABILITY

This invention can be used in Electric Commerce using the Internet.

1. A business method for real-time group-buying and for enabling group-buying wherever each buyer selects commodities; sequentially comprising:
1) A step for group-buying preparation, i.e. for making (an) organization(s), comprising:
buyers and sellers register themselves as members of said group-buying of this invention;
buyers download ‘Client Module’ for participation in said group-buying;
sellers register their commodities and ‘the terms of selling including prices’;
2) A step for selection of commodities; wherein a buyer selects commodities which he wants by one method among:
a buyer logs in a certain shopping mall at random through the Internet by his/her PC, and then he/she searches and selects commodities which he/she wants;
a buyer logs in the group-buying shopping mall through the Internet by his/her PC, and then he/she searches and selects commodities which he/she wants;
a buyer registers commodities by key them in which he wants;
3) A step for registration of buying intent; wherein the buyer's PC transfers “the name or ID of commodities selected at the previous step 2), ‘selling condition including price’ and seller's name or ID” to ‘Group-buying Server’;
4) A step for extraction of sellers; comprising:
‘Group-buying Server’ identifies the commodities registered at the previous step 3);
‘Group-buying Server’ compares ‘the terms of selling including prices’ including prices between sellers registered and sellers unregistered on ‘Group-buying Server’;
‘Group-buying Server’ make a list of sellers selling the commodities in order of advantageousness to buyers in ‘the terms of selling including prices’;
5) A step for transfer of ‘the terms of selling including prices’; wherein ‘Group-buying Server’ transfers the ‘the terms of selling including prices’ including sellers' list made at the previous step 4) to the buyer's PC who registered his buying intent on the commodities;
6) A step for selecting one among buying methods; wherein the buyer selects ‘Group-buying’ which means to select the optimum one among sellers registered, or the buyer selects the individual-buying which means to select one among sellers unregistered;
7) A step for registration of a buying contract; wherein the selected result at the previous step 6) gets transferred to ‘Group-buying Server’ from the buyer's PC, such as ‘Group-buying or individual-buying;
8) A step for informing the buyer and/or the seller of the contract in order to transact business; wherein ‘Group-buying Server’ transfers data for the transaction of group-buying including buying intent, commission, price, buyer's address for destination to the buyer's PC and the seller's PC;

2. The business method of claim 1; wherein the step 3) for registration of (a) buying intent(s) includes a further variation, wherein the buyer registers his buying intent by one method among:
The buyer puts commodities he want in the group-buying mall(s) at his PC; and subsequently the buyer's PC perceives the buying intent, and transfers ‘the name of the commodities’
The buyer puts commodities he wants in the shopping cart or the wish list of a certain shopping mall through the Internet wherever the buyer selects commodities; and subsequently the buyer's PC perceives the buying intent, and transfers ‘the name of the commodities’, ‘the terms of selling including prices’ of the commodities', and ‘information about the seller’;
The buyer fills in a purchase order of ‘Group-buying Server’ with commodities he wants at his PC; and subsequently the buyer's PC transfers the names of commodities selected.

3. The business method of claim 1, for increasing new sellers who participate in, the registration of sellers in the step 1) for group-buying preparation', wherein said sellers unregistered can register themselves as members of said group-buying by the method further comprising:
buyers select commodities at a certain shopping mall;
buyers' PC send information of said commodities to ‘Group-buying Server’;
‘Group-buying Server’ send an e-mail proposing participation in said group-buying automatically if said seller is not registered as a member of said group-buying;
the seller to receive said proposal becomes a seller registered if he agree to said proposal, or he remains a seller unregistered if he disagree to said proposal;

4. The business method of claim 1; wherein the step 7) for registration of a buying contract and the step 8) for informing the buyer and/or the seller of the contract in order to transact business include additionally ‘a step for settlement of an account’; comprising
1) if a result selected by the buyer is group-buying, the result selected is transferred to ‘Group-buying Server’, and also the buyer sends the payment for the commodities to ‘Intermediary’ who is operating ‘Group-buying Server’ during the step 7) for registration of a buying contract;
2) ‘Group-buying Server’ settles the account with the seller considering a commission of the group-buying when the buyer informs ‘Group-buying Server’ that he receives the commodities during the step 8) for informing the buyer and/or the seller of the contract in order to transact business;

5. The business method according to claim 1; wherein, the step 1) for group-buying preparation, the registration of commodities and services includes a variation, wherein sellers register ‘each price of each commodity to each buyer’ differently by the amount of buying during some period and/or by buying frequency.

6. The business method of claim 1, the step 1) for group-buying preparation, registration, the registration of sellers includes a variation, wherein the operator who runs ‘Group-buying Server’ registers himself as a seller registered.

7. The business method of claim 1, the step 1) for group-buying preparation, registration of buyers includes a variation, wherein some buyers register themselves as a sub-group for group-buying, comprising:
a certain buyer registers himself as a group-buying intermediary on the behalf of a certain group in some categories of commodities;
a buyer who wants to join said sub-group registers himself as a member of said sub-group for group-buying;
a buyer registered as a member of said sub-group buys commodities; wherein ‘Group-buying Server’ perceives said buying as buying by said sub-group.

8. The business method of claim 1; wherein in order to save sellers registered previously, the step 5) for transfer of ‘the terms of selling including prices” includes variations, comprising:
sellers whose registration does not last for specified period among sellers registered are not shown among the seller's list during the step 5);
or, only sellers who are selected by a buyer among sellers unregistered are shown among the seller's list during the step 5).
